(19) United States
(12) Patent Application Publication
(10) Pub. No.: US 2015/0252717 A1
(43) Pub. Date: Sep. 10, 2015

(54) ENCAPSULATING APPARATUS OF INTERCOOLER OF VEHICLE

(71) Applicant: Hyundai Motor Company, Seoul (KR)

(72) Inventors: Dong Hwan KIM, Seoul (KR); Su Hwan KIM, Hwaseong-si (KR); Dang Hee PARK, Seoul (KR); Ho Je SOHN, Seoul (KR); Wan Je CHO, Hwaseong-si (KR)

(73) Assignee: Hyundai Motor Company, Seoul (KR)

(21) Appl. No.: 14/543,605

(22) Filed: Nov. 17, 2014

(30) Foreign Application Priority Data
Mar. 7, 2014 (KR) 10-2014-0026957

(51) Int. Cl. F02B 29/04; F02B 77/11

(52) U.S. Cl. CPC F02B 29/0456; F02B 77/11

(57) ABSTRACT

An encapsulating apparatus of an intercooler of a vehicle may include an encapsulation housing and a flap door. The encapsulation housing may be attached to a rear side of the intercooler exposed to an engine room of the vehicle and block heat from the engine room to protect the intercooler. The flap door may be arranged at a rear side of the encapsulation housing to be opened by vehicle-induced wind induced into the encapsulation housing.

### CROSS-REFERENCE TO RELATED APPLICATION

The present application claims priority of Korean Patent Application Number 10-2014-0026957 filed on Mar. 7, 2014, the entire contents of which application are incorporated herein for all purposes by this reference.

### BACKGROUND OF INVENTION

1. Field of Invention

The present invention relates to an encapsulating apparatus of an intercooler for improvement of cooling effect of an intercooler of a vehicle on which a turbo engine is mounted. More particularly, it relates to an encapsulating apparatus of an intercooler of a vehicle for increasing cooling effect of air fed into an engine through an intake system to improve output and fuel ratio of the engine.

2. Description of Related Art

A turbo engine is called an engine to which a supercharger (a turbocharger) is attached and improves output and fuel ratio in comparison to a common diesel engine by which an intercooler is installed at a front end of an intake manifold to cool an intake air and to increase air density and thus to increase a quantity of the intake air.

The intake air fed to the engine via the intake system of a vehicle is compressed by the supercharger and is under a high temperature and high pressure. The high temperature and high-pressure air is cooled through heat exchange with ambient air or water through the intercooler. Thus, as the higher the cooling effect of the intercooler is the lower temperature of the intake air fed to the engine is, combustion efficiency, output, and fuel ratio of the engine are improved.

The intercooler is classified into an air-cooling intercooler and a water-cooling intercooler according to cooling methods, but a majority of engines employs the air-cooling intercooler.

In general, the air-cooling intercooler cools a high temperature intake air using vehicle-induced wind. However, there is a drawback in that no air flows in the vicinity of the intercooler at engine idling and thus the cooling efficiency is inferior. This means that the engine output does not exhibit normally at a city driving where a vehicle stops and starts frequently and at an acceleration mode of a high performance vehicle.

Meanwhile, an existing air-cooling intercooler, for the guarantee of air volume, is designed such that an air guide is installed at a front end thereof, and an internal structure is provided to generate a simple vortex, or as an integrated bumper system.

However, the intercooler installed with the air guide has drawbacks that a rear side is exposed to an engine room so that efficiency of the intercooler is deteriorated due to temperature of the engine room during the traveling of a vehicle, the intercooler provided with the internal structure for generating a vortex has drawbacks that the internal structure is complicated and has a narrow internal space so that it is practically difficult to implement, and the intercooler with the integrated bumper system cannot secure strength corresponding to the integrated bumper system and collision performance.

In order to improve problem in performance of the air cooling intercoolers, the water cooling intercooler may be adopted. The existing water cooling intercooler cools the intake air using cooling water. However, since a radiator should be provided in addition to the intercooler, costs occur and weight increases due to the added cooling water.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made in an effort to solve the above-mentioned problems and/or other problems. The present invention provides an encapsulating apparatus of an intercooler of a vehicle including an encapsulating mechanism to block convection and/or radiation from a high-temperature air within an engine room such that efficiency of heat exchange of the intercooler can be increased when the vehicle travels and when a vehicle stops.

Moreover, the present invention provides an encapsulating apparatus of an intercooler of a vehicle that includes a bypass, through which a hot air at the rear side of the intercooler is exhausted toward a cooling fan, to guarantee airflow or air volume passing through the intercooler even at an engine idling. The bypass is opened in association with operation of the cooling fan so that cooling efficiency of the intercooler can be maximized.

In accordance with various aspects of the present invention, there is provided an encapsulating apparatus of an intercooler of a vehicle, including: an encapsulation housing attached to a rear side of the intercooler exposed to an engine room of the vehicle and blocking heat from the engine room to protect the intercooler, and a flap door arranged at a rear side of the encapsulation housing to be opened by vehicle-induced wind induced into the encapsulation housing.

According to an aspect of the present invention, the encapsulation housing includes: a bypass connected to a shroud of a cooling module; and a one-way valve installed in the bypass and operated by a pressure difference between a front end and a rear end of the bypass.

According to an aspect of the present invention, the one-way valve is opened in association with operation of a cooling fan provided at a rear side of the shroud when the flap door is closed.

According to an aspect of the present invention, the encapsulation housing comprises a hinge to which the flap door is assembled, and a pivot guide coupled with the hinge to restrict a pivot angle of the flap door.

The encapsulating apparatus of an intercooler of a vehicle according to the present invention generates an outer flow forward and rearward within the intercooler to improve cooling efficiency of the intercooler during the traveling and the engine idling so that fuel ratio and acceleration of a vehicle can be remarkably improved. In addition, the encapsulating apparatus of an intercooler of a vehicle according to the present invention does not need additional parts to generate an outer flow of the intercooler during the engine idle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIGS. 1 and 2 are views illustrating a flap door, opened by vehicle-induced wind, of an exemplary encapsulating apparatus of an intercooler of a vehicle according to the present invention;

FIGS. 3 and 4A-4B are views illustrating a flap door, closed when a vehicle stops, of an exemplary encapsulating apparatus of an intercooler of a vehicle according to the present invention;

FIG. 5 is a view illustrating an ambient air flow generated by a cooling fan when a vehicle stops in an exemplary encapsulating apparatus of an intercooler of a vehicle according to the present invention; and

FIGS. 6A-6B are views illustrating a one-way valve adoptable to an exemplary encapsulating apparatus of an intercooler of a vehicle according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention relates to an encapsulating apparatus of an intercooler for increasing cooling efficiency of the intercooler of a vehicle that is mounted with a turbo engine, and is designed to increase cooling efficiency of air fed to an engine via an intake system and to improve output and fuel ratio of the engine. Particularly, an encapsulating apparatus of an intercooler according to various embodiments of the present invention is configured to generate airflow in the intercooler so that efficiency of the intercooler can be improved.

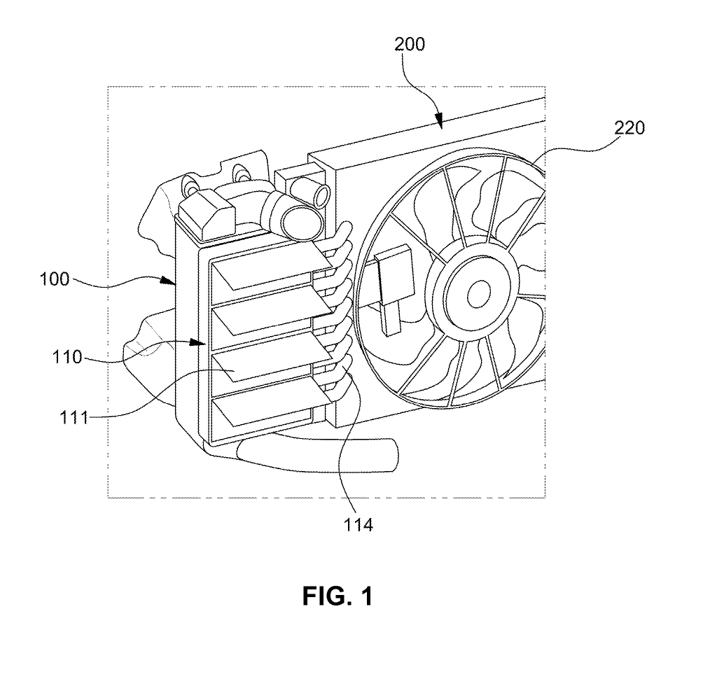

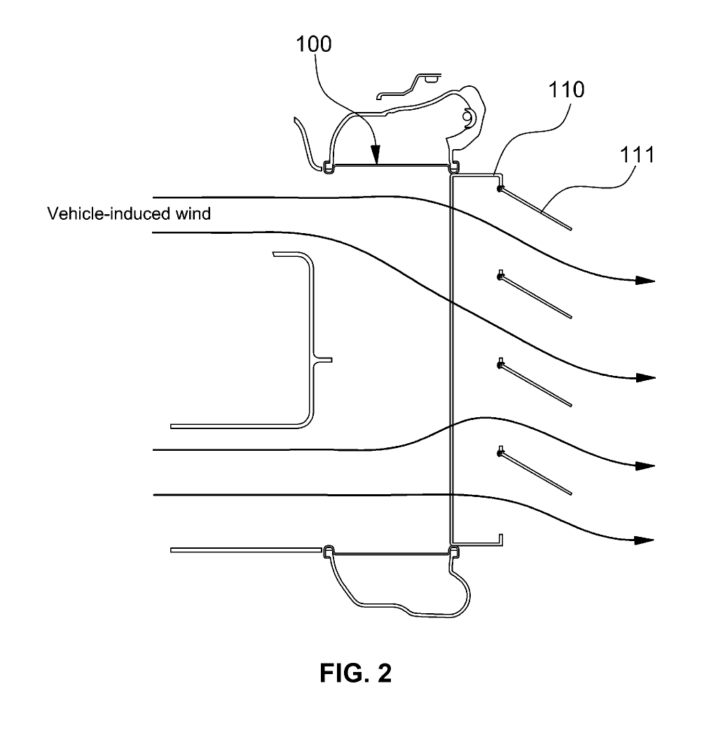

As illustrated in FIGS. 1 and 2, according to various embodiments of the present invention, an intercooler 100 is integrally attached with an encapsulation housing 110 at a rear side thereof. The encapsulation housing 110 is made of plastic isolation material in the form of a case with an internal space and is provided at the rear side of the intercooler 100 in a corresponding side to cover the rear side of an existing intercooler exposed to an engine room and to block heat from the engine room which affects the cooling efficiency of the intercooler.

FIGS. 1 and 2 illustrate flap doors opened by vehicle-induced wind during the traveling of a vehicle. The encapsulation housing 110 is provided at a rear side thereof with flap doors 111 to pivot about hinges. The flap doors 111 are made of elastic bodies, arranged at the rear side of the encapsulation housing 110 in parallel or substantially parallel to each other in vertical direction, and open the rear side of the encapsulation housing 110.

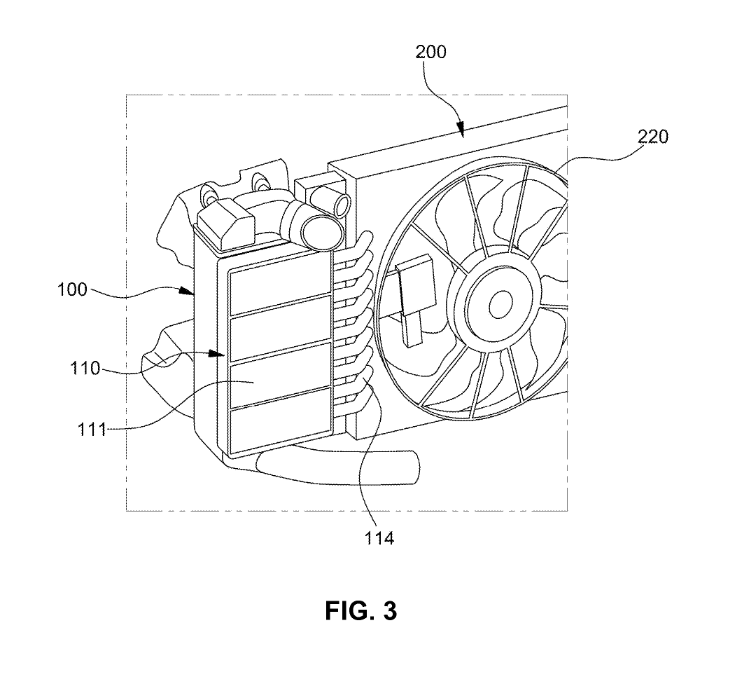

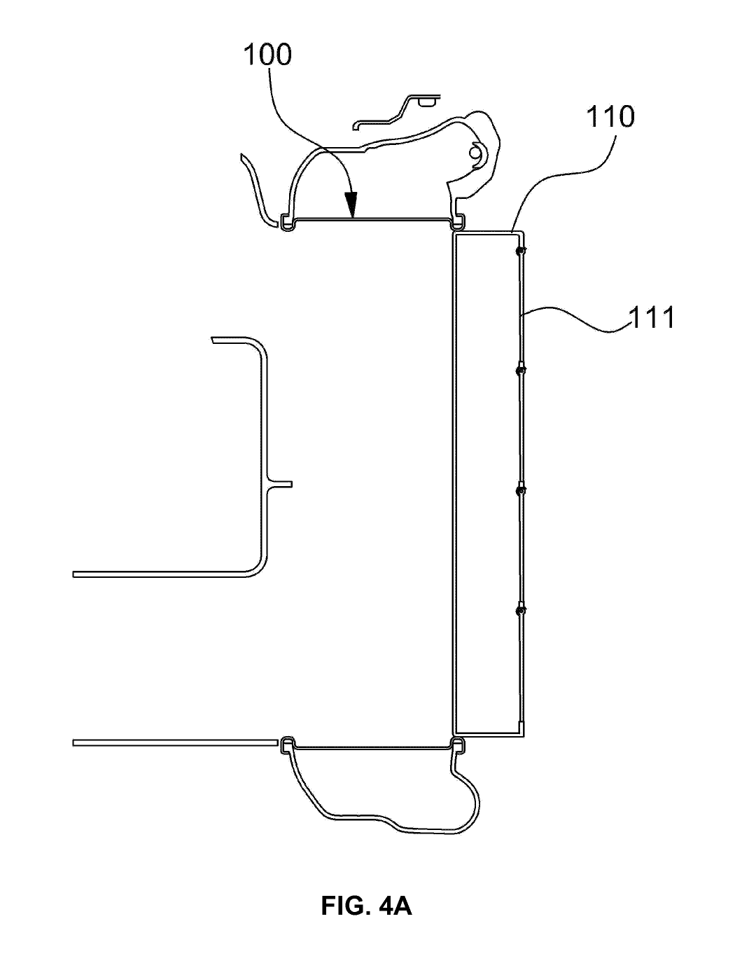

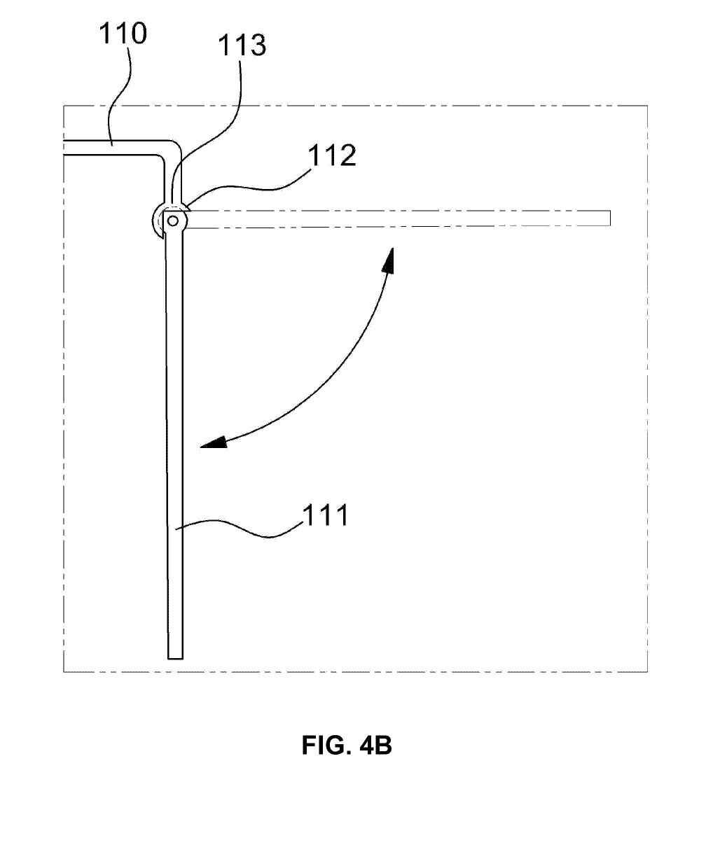

The flap doors 111 are closed when a vehicle stops as illustrated in FIGS. 3 and 4 and are pushed and opened by vehicle-induced wind generated (induced into the encapsulation housing 110 via a front side of the intercooler 100 during the travelling of a vehicle) during the travelling of a vehicle, the pivot angle of which is restricted to 0 degree to 90 degrees by pivot guides 112 as illustrated in FIGS. 4A-4B.

The pivot guides 112 are integrated or coupled with the hinges 113 of the encapsulation housing 110 to which the respective flap doors 111 are assembled and their maximum opening angles are restricted to 90 degrees with reference to the closed state of the flap doors 111.

The pivot guides 112 are configured to restrict the pivot angles of the flap doors 111 at the rear side of the encapsulation housing 110 such that front sides of the flap doors 111 are in close contact with sides of the pivot guides 112 and at the same time pivoting of the flap doors 111 are stopped when the flap doors 111 are opened, and that the rear sides of the flap doors 111 are in close contact with the other sides of the pivot guides 112 and at the same time the pivoting of the flap doors 111 is stopped when the flap doors 111 are closed.

By doing so, the pivot guides 112 restrict the pivot angles of the flap doors 111 to the maximum open angle of 90 degrees when the flap doors 111 are opened and restrict the pivot angles of the flap doors 111 when the flap doors 111 are closed such that the flap doors 111 do not enter the encapsulation housing 110.

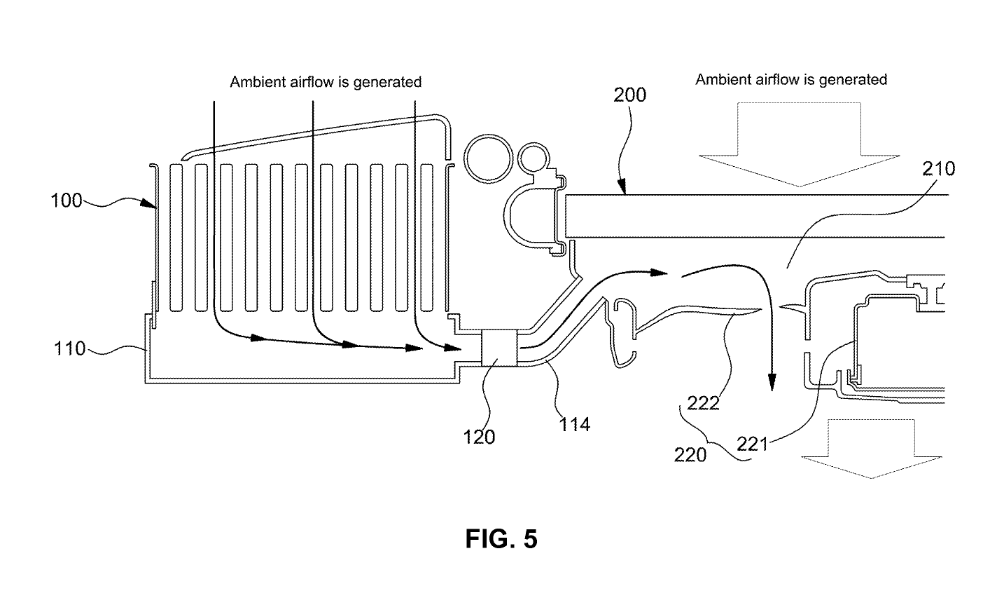

As illustrated in FIGS. 3 and 5, the intercooler 100 is disposed with a cooling module 200 including a shroud 210 provided with an internal space at a right side thereof and a cooling fan 220 provided at the rear side of the shroud 210. For reference, reference numerals 221 and 222 indicate a fan motor 221 and fan blades 222 of the cooling fan respectively.

The shroud 210 is communicated with the encapsulation housing 110 through a bypass 114 provided at a side of the encapsulation housing 110 such that air flows therethrough. The bypass 114 connects the encapsulation housing 110 with the shroud 210 of the cooling module 200 and is installed therein with a one-way valve 120 driven by a pressure difference.

The one-way valve 120 is opened in association with operation of the cooling fan 220 installed at the rear side of the shroud 210 and generates an ambient airflow from the intercooler 100 to the cooling module 200 when the one-way valve 120 is opened in association with operation of the cooling fan 220 at a stopped state of a vehicle where the flap doors 111 are closed.

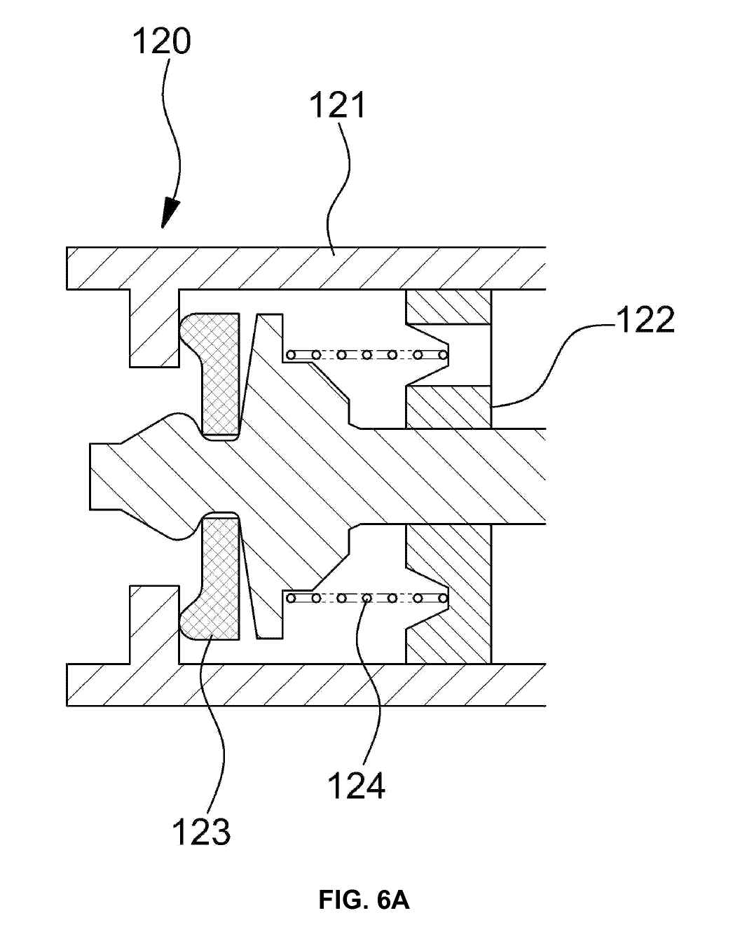

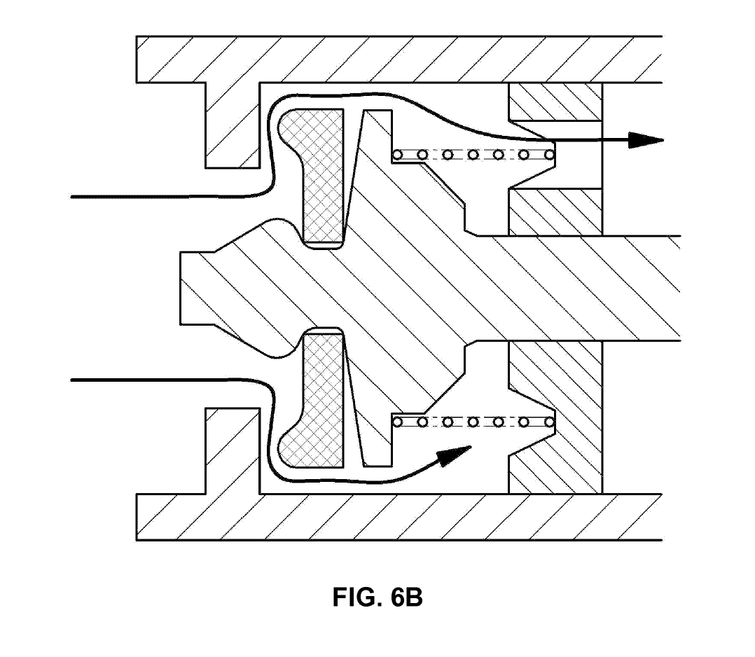

As illustrated in FIGS. 6A-6B, as an example, the one-way valve 120 may include a housing 121 having a passage for airflow, a spring support 122 fixed to the rear end of the housing 121, an opening member 123 opening the passage of the housing 121, and a return spring 124 assembled between the opening member 123 and the spring support 122. In some embodiments, the spring support 122 is provided with a vent for airflow.

The one-way valve 120 keeps being closed by a force of the return spring 124 and the opening member 123 is pushed and moved due to a pressure difference generated between front and rear ends of the housing 121 (that is, between both ends of the valve) and at the same time the passage for airflow is opened.

The one-way valve 120 is opened by which the opening member 123 is pushed due to the pressure difference when forward and rearward airflow is generated within the shroud 210 of the cooling module 200 by operation of the cooling fan 220 at the stopped state of a vehicle such as engine idle and the pressure difference is generated between the front end and the rear end of the bypass 114. In this case, air in the encapsulation housing 110 moves toward the shroud 210 so that airflow is generated forward and rearward in the intercooler 100.

According to an existing or conventional apparatus, there is no airflow in the intercooler so that cooling efficiency of the intercooler is deteriorated at the engine idle. According to the encapsulating apparatus of the present invention, airflow is generated in the intercooler even at the engine idle, so that airflow or air volume passing through the intercooler can be guaranteed and thus cooling efficiency can be maximized.

For convenience in explanation and accurate definition in the appended claims, the terms “front” or “rear”, “left” or “right”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An encapsulating apparatus of an intercooler of a vehicle, comprising:
an encapsulation housing attached to a rear side of the intercooler exposed to an engine room of the vehicle and blocking heat from the engine room to protect the intercooler; and
a flap door arranged at a rear side of the encapsulation housing to be opened by vehicle-induced wind induced into the encapsulation housing.

2. The encapsulating apparatus of claim 1, wherein the encapsulation housing comprises:
a bypass connected to a shroud of a cooling module; and
a one-way valve installed in the bypass and operated by a pressure difference between a front end and a rear end of the bypass.

3. The encapsulating apparatus of claim 2, wherein the one-way valve is opened in association with operation of a cooling fan provided at a rear side of the shroud when the flap door is closed.

4. The encapsulating apparatus of claim 1, wherein the encapsulation housing comprises:
a hinge to which the flap door is assembled; and
a pivot guide coupled with the hinge to restrict a pivot angle of the flap door.
